(19) United States
(12) Patent Application Publication
(10) Pub. No.: US 2014/0106740 A1
(43) Pub. Date: Apr. 17, 2014

(54) BLIND AND TRAFFIC DEMAND BASED CONFIGURATIONS OF COMPRESSED MODE FOR INTER-FREQUENCY FEMTOCELL SEARCH

(71) Applicant: QUALCOMM INCORPORATED, San Diego, CA (US)

(72) Inventors: Yan Zhou, San Diego, CA (US); Damanjit Singh, San Diego, CA (US)

(73) Assignee: QUALCOMM Incorporated, San Diego, CA (US)

(21) Appl. No.: 13/652,350

(22) Filed: Oct. 15, 2012

(51) Int. Cl. H04W 24/00

(52) U.S. Cl. 455/423; 455/422.1

(57) ABSTRACT

Techniques are provided for femtocell search using blind and traffic demand-based configurations for compressed mode. For example, a method includes configuring a type-1 cluster of transmission gaps for a mobile entity. The method may include receiving, during one transmission gap of the type-1 cluster of transmission gaps, signal measurements of the second network node from the mobile entity. The method may include configuring a type-2 cluster of transmission gaps for the mobile entity in response to receiving the signal measurements of the second network node.

### BACKGROUND

I. Field

The present disclosure relates to communication systems and to techniques for inter-frequency femtocell search.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of mobile entities, such as, for example, user equipments (UEs). A UE may communicate with a base station via the downlink (DL) and uplink (UL). The DL (or forward link) refers to the communication link from the base station to the UE, and the UL (or reverse link) refers to the communication link from the UE to the base station.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs.

In recent years, users have started to replace fixed line broadband communications with mobile broadband communications and have increasingly demanded great voice quality, reliable service, and low prices, especially at their home or office locations. In order to provide indoor services, network operators may deploy different solutions. For networks with moderate traffic, operators may rely on macro cellular base stations to transmit the signal into buildings. However, in areas where building penetration loss is high, it may be difficult to maintain acceptable signal quality, and thus other solutions are desired. New solutions are frequently desired to make the best of the limited radio resources such as space and spectrum. Some of these solutions include intelligent repeaters, remote radio heads, and small-coverage base stations (e.g., picocells and femtocells).

The Femto Forum, a non-profit membership organization focused on standardization and promotion of femtocell solutions, defines femto access points (FAPs), also referred to as femtocell units, to be low-powered wireless access points that operate in licensed spectrum and are controlled by the network operator, can be connected with existing handsets, and use a residential digital subscriber line (DSL) or cable connection for backhaul. In various standards or contexts, a FAP may be referred to as a home node B (HNB), home e-node B (HeNB), access point base station, etc.

User terminal devices, such as UEs, served by a macrocell may be in the vicinity of other access points (e.g., FAPs) that may better serve them. Accordingly, there remains a need for an improved technique by which a terminal device may search for and take measurements of other access points.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Disclosed are an apparatus and a method operable by a first network node. According to one aspect, the method includes configuring a type-1 cluster of transmission gaps for a mobile entity prior to receiving signal measurements of a second network node from the mobile entity. The method further includes receiving, during one transmission gap of the type-1 cluster of transmission gaps, signal measurements of the second network node from the mobile entity. The method further includes configuring a type-2 cluster of transmission gaps for the mobile entity in response to receiving the signal measurements of the second network node.

According to another aspect, a wireless communication apparatus includes at least one processor configured to configure a type-1 cluster of transmission gaps for a mobile entity prior to receiving signal measurements of a second network node from the mobile entity. The at least one processor is further configured to receive, during one transmission gap of the type-1 cluster of transmission gaps, signal measurements of the second network node from the mobile entity. The at least one processor is further configured to configure a type-2 cluster of transmission gaps for the mobile entity in response to receiving the signal measurements of the second network node. The wireless communication apparatus also includes a memory coupled to the at least one processor for storing data.

According to another aspect, wireless communication apparatus includes means for configuring a type-1 cluster of transmission gaps for a mobile entity prior to receiving any signal measurements of a second network node from the mobile entity. The wireless communication apparatus further includes means for receiving, during one transmission gap of the type-1 cluster of transmission gaps, signal measurements of the second network node from the mobile entity. The wireless communication apparatus further includes means for configuring a type-2 cluster of transmission gaps for the mobile entity in response to receiving the signal measurements of the second network node.

According to another aspect, a computer program product includes a computer-readable medium including code for causing at least one computer to configure a type-1 cluster of transmission gaps for a mobile entity prior to receiving any signal measurements of a second network node from the mobile entity. The computer-readable medium further includes code for causing the at the least one computer to receive, during one transmission gap of the type-1 cluster of transmission gaps, signal measurements of the second network node from the mobile entity. The computer-readable medium further includes code for causing the at the least one computer to configure a type-2 cluster of transmission gaps for the mobile entity in response to receiving the signal measurements of the second network node.

According to another aspect, a wireless communication method operable by a network entity includes scheduling a transmission gap based at least on one of an expiration of a timer or a traffic transmission indication. The method further includes during the transmission gap, at least one of monitoring a signal from another network entity or measuring out-of-cell interference levels.

According to another aspect, a wireless communication apparatus includes at least one processor configured to schedule a transmission gap based at least on one of an expiration of a timer or a traffic transmission indication. The at least one processor is further configured to during the transmission gap, at least one of monitor a signal from another network entity or measure out-of-cell interference levels. The wireless communication apparatus further includes a memory coupled to the at least one processor for storing data.

According to another aspect, a wireless communication apparatus includes means for scheduling a transmission gap based at least on one of an expiration of a timer or a traffic transmission indication. The wireless communication apparatus further includes means for, during the transmission gap, at least one of monitoring a signal from another network entity or measuring out-of-cell interference levels.

According to another aspect, a computer program product includes a computer-readable medium including code for causing at least one computer to schedule a transmission gap based at least on one of an expiration of a timer or a traffic transmission indication. The computer-readable medium further includes code for causing the at least one computer to during the transmission gap, at least one of monitor a signal from another network entity or measure out-of-cell interference levels.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 is a block diagram conceptually illustrating an example of a telecommunications system.

FIG. 2 is a block diagram conceptually illustrating an example of a down link frame structure in a telecommunications system.

FIG. 3 is a block diagram conceptually illustrating a design of a base station/eNB and a UE.

FIG. 4 is a block diagram illustrating another example communication system.

FIG. 5 is a simplified block diagram of several sample aspects of a communication system.

FIG. 6 illustrates a block diagram illustrating messaging among the UE, eNB, and femtocell for blind configuration for compressed mode.

FIGS. 7A-B are exemplary timeline diagrams for blind configuration for compressed mode.

FIG. 8 is an exemplary timeline diagram for traffic demand based configuration for compressed mode.

FIG. 9 is an exemplary timeline diagram for traffic demand based measurement for out-of-cell signals.

FIGS. 10A-C illustrate aspects of a methodology for blind configuration for compressed mode.

FIGS. 11A-B illustrate aspects of a methodology for traffic demand based configuration for measurement reporting.

FIGS. 12A-C show embodiments of apparatus for blind configuration for compressed mode by network node, in accordance with the methodologies of FIGS. 10A-C.

FIGS. 13A-B show embodiments of an apparatus for traffic demand based configuration for measurement reporting, in accordance with the methodologies of FIGS. 11A-B.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

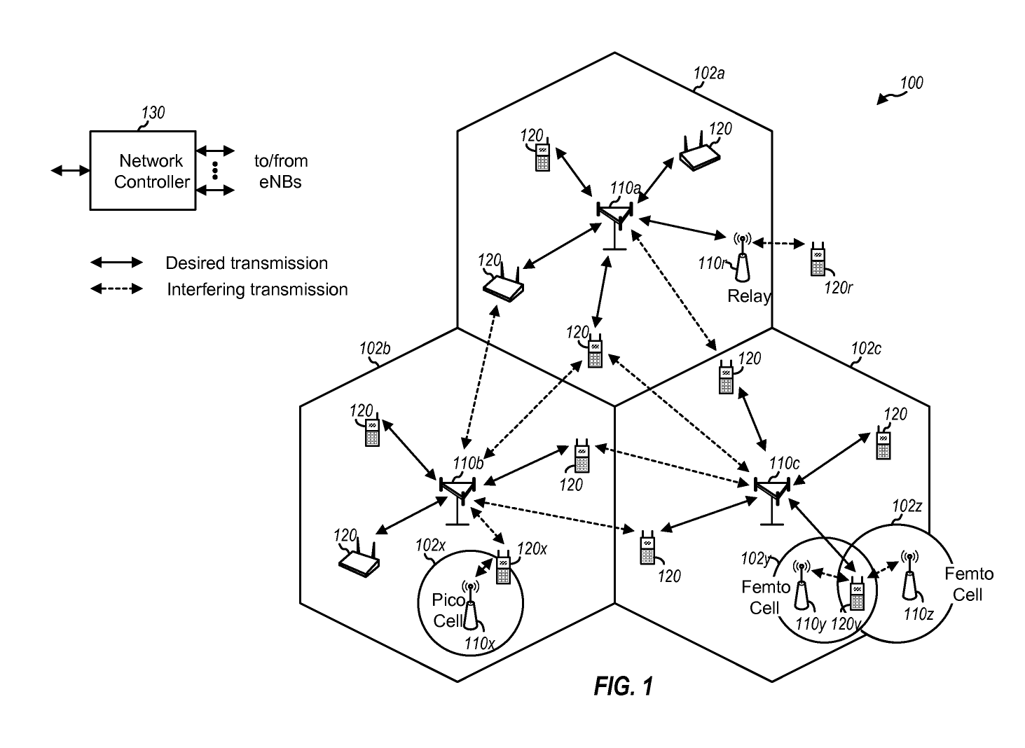

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB (HNB). In the example shown in FIG. 1, the eNBs 110a, 110b and 110c may be macro eNBs for the macro cells 102a, 102b and 102c, respectively. The eNB 110x may be a pico eNB for a pico cell 102x. The eNBs 110y and 110z may be femto eNBs for the femto cells 102y and 102z, respectively. An eNB may support one or multiple (e.g., three) cells.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wired backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, or other mobile entities. A UE may be able to communicate with macro eNBs, pico eNBs, femto eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

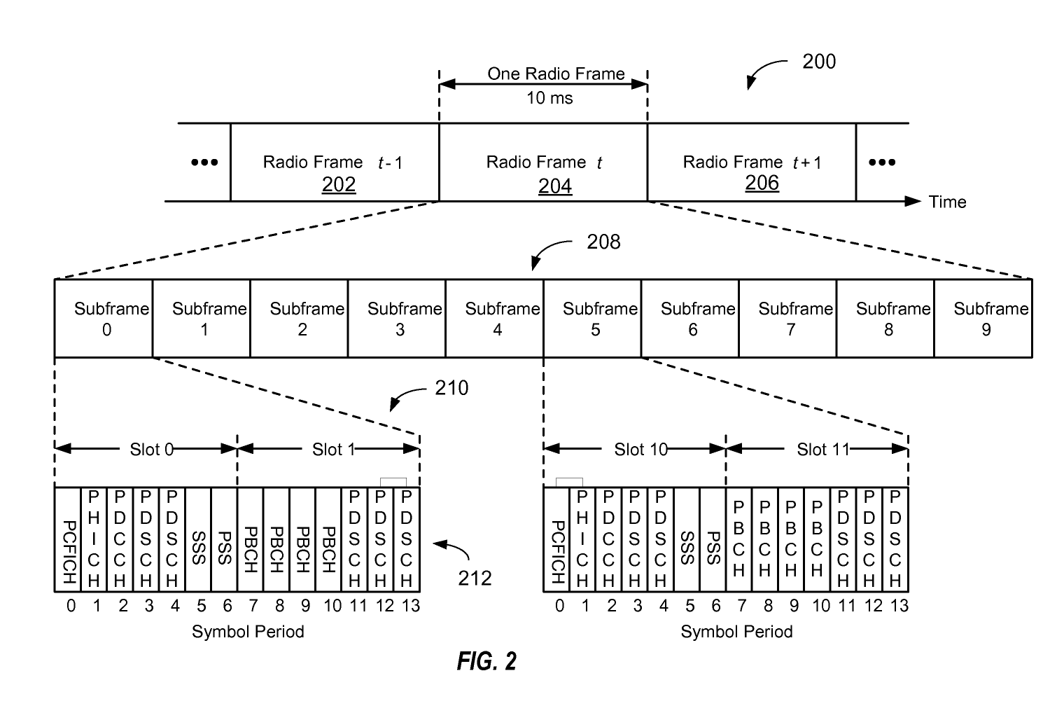

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A UE may be within the coverage of multiple eNBs. One of these eNBs may be selected to serve the UE. The serving eNB may be selected based on various criteria such as received power, path loss, signal-to-noise ratio (SNR), etc.

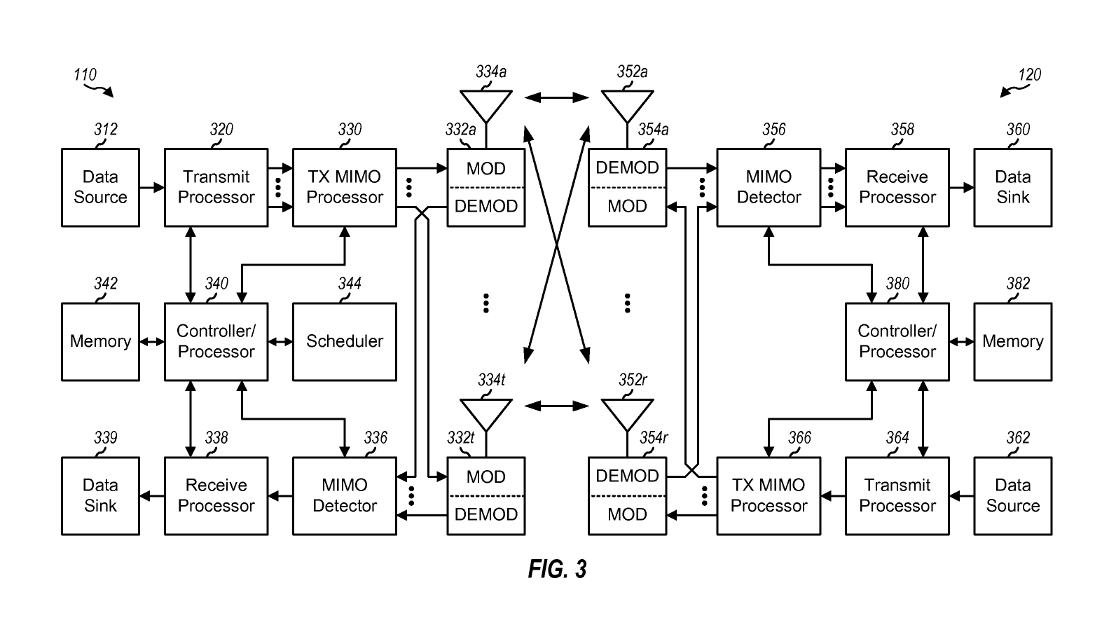

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type such as an access point including a femtocell, a picocell, etc. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

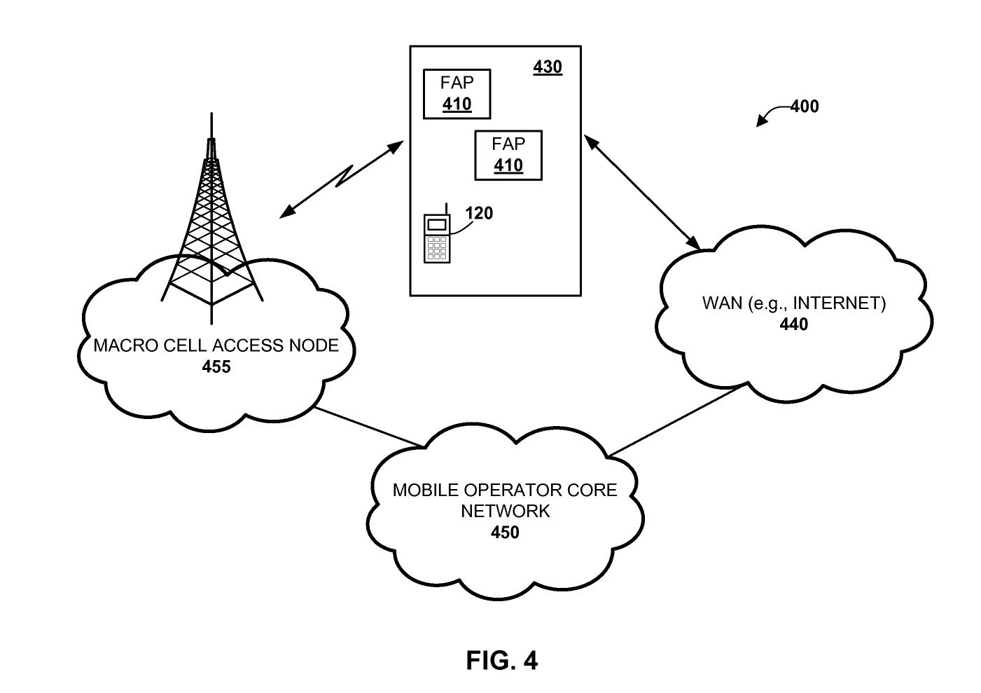

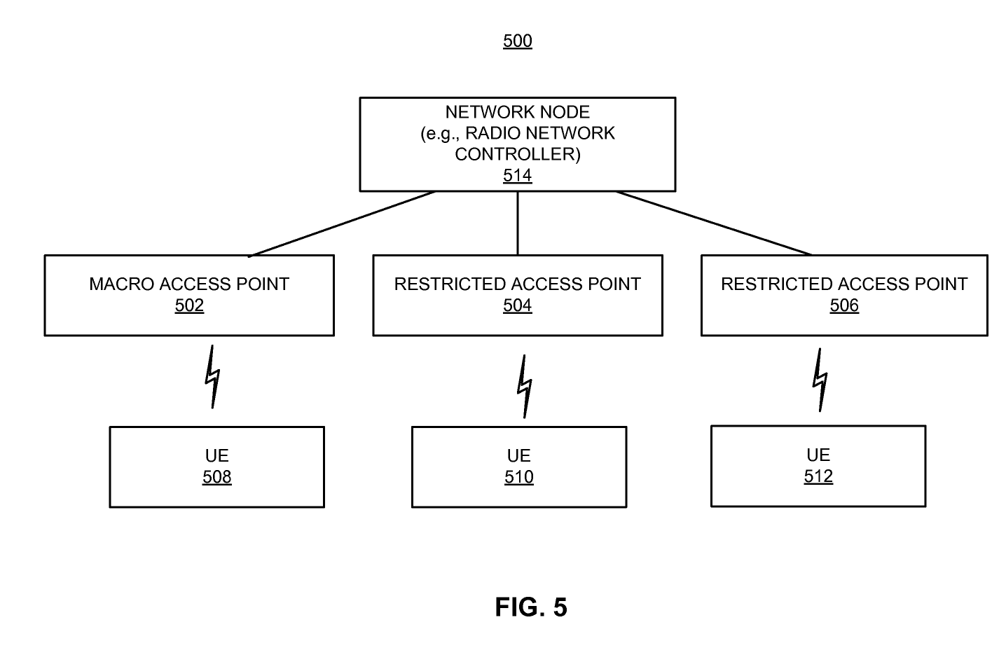

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4 and 5, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

FIG. 4 is an illustration of a planned or semi-planned wireless communication environment 400, in accordance with various aspects. Communication environment 400 includes multiple access point base stations, including FAPs 410, each of which are installed in corresponding small scale network environments. Examples of small scale network environments can include user residences, places of business, indoor/outdoor facilities 430, and so forth. The FAPs 410 can be configured to serve associated UEs 120 (e.g., included in a CSG associated with FAPs 410), or optionally alien or visitor UEs 120 (e.g., UEs that are not configured for the CSG of the FAP 410). Each FAP 410 is further coupled to a wide area network (WAN) (e.g., the Internet 440) and a mobile operator core network 450 via a DSL router, a cable modem, a broadband over power line connection, a satellite Internet connection, or the like.

To implement wireless services via FAPs 410, an owner of the FAPs 410 subscribes to mobile service offered through the mobile operator core network 450. Also, the UE 120 can be capable to operate in a macro cellular environment and/or in a residential small scale network environment, utilizing various techniques described herein. Thus, at least in some disclosed aspects, FAP 410 can be backward compatible with any suitable existing UE 120. Furthermore, in addition to the macro cell mobile network 455, UE 120 is served by a predetermined number of FAPs 410, specifically FAPs 410 that reside within a corresponding user residence(s), place(s) of business, or indoor/outdoor facilities 430, and cannot be in a soft handover state with the macro cell mobile network 455 of the mobile operator core network 450. It should be appreciated that although aspects described herein employ 3GPP terminology, it is to be understood that the aspects can also be applied to various technologies, including 3GPP technology (Release 99 [Re199], Re15, Re16, Re17), 3GPP2 technology (1xRTT, 1xEV-DO Re10, RevA, RevB), and other known and related technologies.

FIG. 5 illustrates sample aspects of a communication system 500 where distributed nodes (e.g., access points 502, 504, and 506) provide wireless connectivity for other nodes (e.g., UEs 508, 510, and 512) that may be installed in or that may roam throughout an associated geographical area. In some aspects, the access points 502, 504, and 506 may communicate with one or more network nodes (e.g., a centralized network controller such as network node 514) to facilitate WAN connectivity.

An access point, such as access point 504, may be restricted whereby only certain mobile entities (e.g., UE 510) are allowed to access the access point, or the access point may be restricted in some other manner. In such a case, a restricted access point and/or its associated mobile entities (e.g., UE 510) may interfere with other nodes in the system 500 such as, for example, an unrestricted access point (e.g., macro access point 502), its associated mobile entities (e.g., UE 508), another restricted access point (e.g., access point 506), or its associated mobile entities (e.g., UE 512). For example, the closest access point to a given UE may not be the serving access point for the given UE.

In some cases, the UE 510 may generate measurement reports (e.g., on repeated basis). In some aspects, such a measurement report may indicate which access points the UE 510 is receiving signals from, a received signal strength indication associated with the signals from each access point (e.g., Ec/Io), the PL to each of the access points, or some other suitable type of information. In some cases a measurement report may include information relating to any load indications the UE 510 received via a DL. The network node 514 may then use the information from one or more measurement reports to determine whether the access point 504 and/or the UE 510 are relatively close to another node (e.g., another access point or UE).

In some cases, the UE 510 may generate information that is indicative of the signal to noise ratio (e.g., signal and interference to noise ratio, SINR) on a DL. Such information may comprise, for example a channel quality indication (“CQI”), a data rate control (“DRC”) indication, or some other suitable information. In some cases, this information may be sent to the access point 504 and the access point 504 may forward this information to the network node 514 for use in interference management operations. In some aspects, the network node 514 may use such information to determine whether there is interference on a DL or to determine whether interference in the DL is increasing or decreasing.

As discussed above, an eNB may provide communication coverage for a macro cell, a picocell, a femtocell, and/or other types of cell. Capacity offload gains of a femtocell network are maximized when femtocells are deployed on a dedicated carrier, and thus, there is no interference from a macro network on the same channel as the deployed femtocells. However, because bandwidth is such a scarce resource, bandwidth needs to be allocated and managed with great care and efficiency. Accordingly, an operator may decide if and/or when to dedicate a carrier to femtocells to maximize the capacity of the network.

In accordance with one or more embodiments of the present disclosure, there are provided techniques for configuring a compressed mode for inter-frequency search by a UE. Compressed mode allows the UE to temporarily tune to another frequency, and make measurements of another frequency or another radio access technology while maintaining an existing dedicated channel with an eNB. For example, the UE may tune to the frequency of a nearby femtocell to make measurements of the nearby femtocell. To offload a macrocell, an active UE served by the macrocell on a macro-only carrier may switch to the nearby accessible femtocell on another frequency. To do this, the UE may need to perform a search, and hence obtain information for the nearby femtocell. However, the inter-frequency search may not be triggered if the macrocell quality is good on the macro-only frequency. The femtocell may transmit a beacon signal on the macro-only frequency where the beacon signal may degrade the macrocell signal quality and force the UE to search when approaching the femtocell. In an alternative, the search may be triggered once the UE is in the femtocell's proximity, which can be detected based on the macrocell PSCs nears the femtocell. However, the beacon signal may introduce additional interference to other nearby UEs, and accurate femtocell proximity detection is challenging in practice.

In order to address this problem as well as provide other potential advantages, an alternate search procedure uses blind and traffic demand-based configurations for compressed mode. In the blind configuration set up, a eNB or the macro RNC, via the eNB, may blindly configure the UE on a macro-only carrier to be in compressed mode with periodic sparse transmission gaps, which are sparse enough to insignificantly affect a UE's service quality. For example, the macro RNC blindly configures the UE to be in compressed mode without knowing whether the UE is in proximity of an access point (e.g., a femtocell) and without receiving any measurements associated with the access point. In the traffic demand based configuration, the transmission gaps may be non-periodic and configured at times when the UE has no significant traffic demands, so that the UE may tune to other frequencies for measurement without significantly interrupting data transmission at the UE. With the configured transmission gaps, the UE may search for femtocell PSCs on different frequencies. Once the UE detects the PSCs, the UE may report the femtocell PSCs and the associated frequencies to the macro RNC. After the macro RNC receives the report, the macro RNC may configure the UE to measure the detected femtocell PSC quality with regularly spaced dense transmission gaps, to verify if the quality of the femtocell PSC is good and stable. If the femtocell PSC is stable, the UE may report the stable femtocell PSC to the macro RNC, which may initiate inter-frequency handover of the UE to the detected femtocell.

Compared to both transmitting the beacon signal on the macro-only frequency and proximity method, the blind and traffic demand based configurations of compressed mode have the advantage of not introducing interference and do not require femtocell proximity detection.

In an example, to offload a macrocell, the compressed mode with periodic sparse transmission gaps may be blindly configured by the network for UEs near a macrocell site, where the inter-frequency cell search will not be typically triggered due to good macrocell quality. After the UE declares the detection of a femtocell in the UE's proximity, the subsequent UE search for the femtocell may still fail due to the inaccurate proximity indication. In this case, the compressed mode with sparse transmission gaps may be activated to continue the search with negligible impact on UE service quality. It will be deactivated once the UE moves out of proximity of the femtocell.

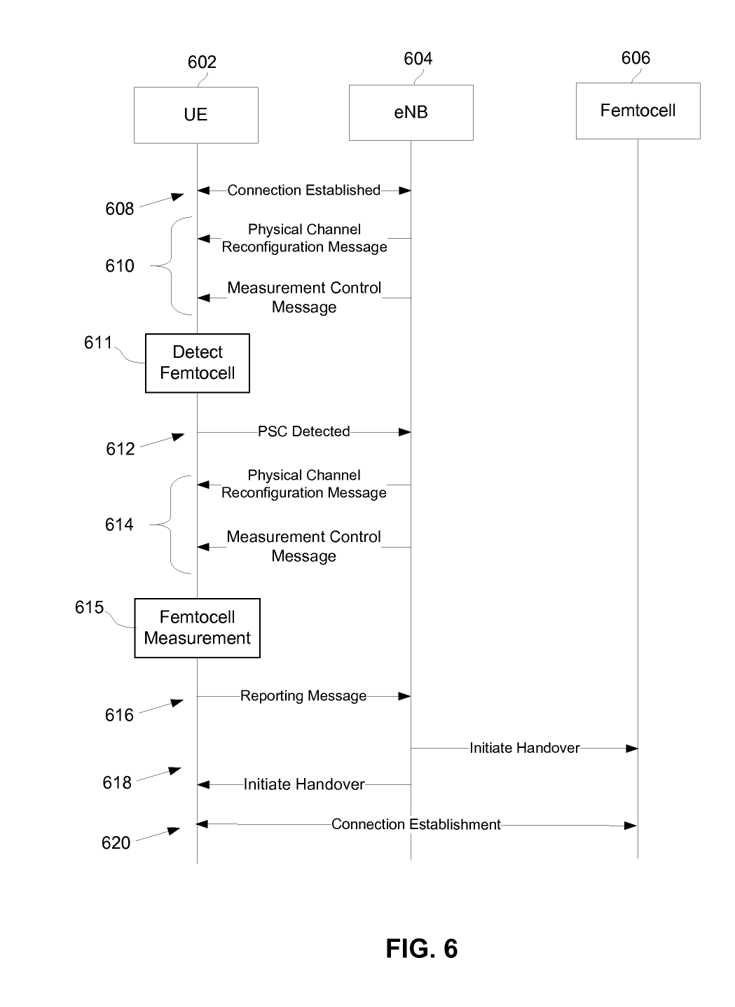

FIG. 6 illustrates a block diagram for blind configuration for compressed mode. In a first embodiment, to offload the macrocell, the blind configuration for compressed mode for a UE 602 served by the macrocell (e.g., eNB 604) may include the following procedure. Sparse and dense transmission gaps may be configured between data transmission intervals. eNB 604 or the macro RNC, via eNB 604, may first configure and activate the UE 602 in compressed mode with periodic sparse transmission gaps and to report detected femto PSCs on other frequencies. The sparse transmission gap compressed mode configuration and activation may be performed by sending a physical channel reconfiguration message, at 610, to the UE 602 with the following information: interval between adjacent gaps, e.g., 5 seconds for sparse transmission gaps; length per gap, e.g., 10 slots; and maximum gap repetition times, e.g., no maximum. The report of detected PSCs and associated frequencies may be performed by sending a measurement control message, at 610, to the UE 602 with the following information: the frequencies to search and femtocell PSCs per frequency; event type to trigger report, e.g., Event 2c (report if detected PSC quality is above a threshold); and time to trigger report, e.g., immediately after detection (0 seconds) for prompt reporting. The messages may be sent to the UE after call setup, at 608. Once a femtocell PSC is detected, at 611, the UE will report it to the macro RNC, via eNB 604. The macro RNC may reconfigure the UE 602, at 614, with regular dense gaps to verify the femtocell PSC quality. The dense-gap compressed mode configuration and activation may be done by sending a physical channel reconfiguration message to the UE with the following information: interval between adjacent gaps, e.g., 250 ms for dense gaps; length per gap, e.g., 10 slots; and maximum gap repetitions, e.g., 40 repetitions. The measurement control message should also be updated with the following information: PSCs to search, the detected PSC on the associated frequency; event type to trigger report, e.g., Event 2c; and time to trigger report, e.g., 1.28 seconds for stable quality.

If the UE detect the femtocell PSC with good and stable quality, at 615, the UE may report to the macro RNC, at 616. The macro RNC may initiate inter-frequency handover, at 618, for the UE 602 to that femtocell 606. Otherwise, the macro RNC may make the UE 602 return to the sparse-gap compressed mode by resending the messages as described at step 610.

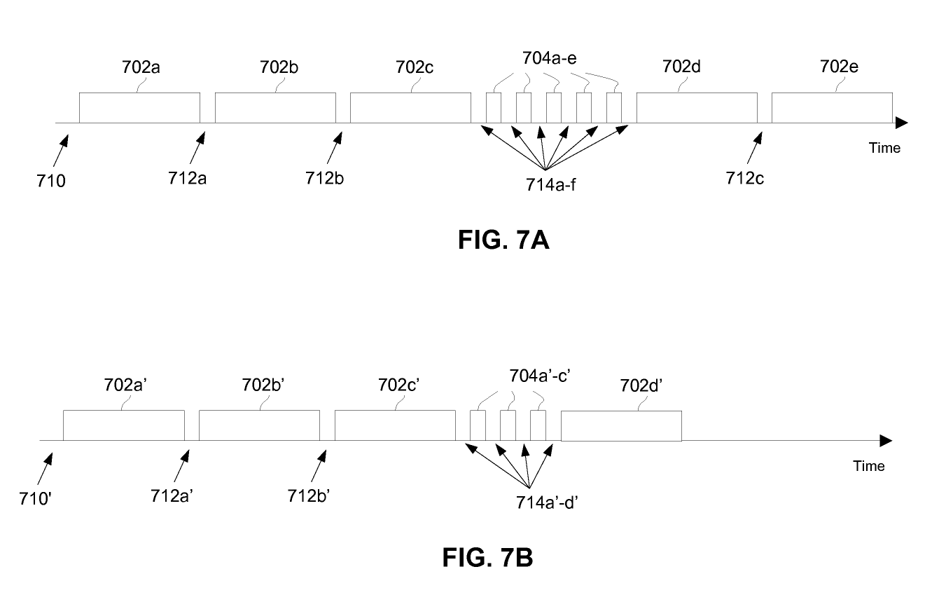

FIG. 7A illustrates dense transmission gaps configured between sparse transmission gaps, according to the messaging illustrated in FIG. 6. As illustrated in FIG. 7A, sparse and dense transmission gaps may be configured between transmission periods 702a-e. In one example illustrated in FIG. 7A, a UE 602 is in the vicinity of femtocell 606. The UE 602 is initially configured for sparse transmission gaps by the macro RNC, via the eNB 604, and the UE 602 is then reconfigured for dense transmission gaps. At time 710, the macro RNC configures the UE, via a physical channel reconfiguration message to the UE 602, with sparse periodic transmission gaps. The physical channel reconfiguration message indicates a 5 second interval between adjacent gaps, 10 slots per gap, and continuous repetition. The macro RNC also sends a measurement control message to the UE indicating the frequency for femtocell 606 and the PSC for femtocell 606. The measurement control message indicates an Event 2c trigger type, indicating to report a detected PSC if the quality is above a threshold. The measurement control message includes a 0 second time to trigger measurement reporting by the UE, to indicate to the UE to report a detected PSC immediately. The UE 602 communicates with the eNB 604 during transmission period 702a. At transmission gap 712a, transmission between the eNB and UE ceases, and the UE 602 performs a frequency search, using the frequency of femtocell 606. The UE 602 is outside of the range of femtocell 606 and does not find femtocell 606. During transmission period 702c, transmission between the eNB 604 and the UE 602 resumes. At transmission gap 712b, the UE 602 moves closer to femtocell 606 and performs a frequency search, using the frequency of femtocell 606. The UE finds the femtocell and determines the quality of the detected PSC is above the threshold set in the measurement control message. The UE 602 reports the detected PSC of the femtocell 606 to the eNB 604. Based on the detected PSC, during transmission period 702c, the macro RNC configures UE 602, via a physical channel reconfiguration message to the UE 602, with dense periodic transmission gaps. The physical channel reconfiguration message indicates a 250 millisecond interval between adjacent gaps, 10 slots per gap, and 6 repetitions. The macro RNC also sends a measurement control message to the UE 602 indicating the frequency for femtocell 606 and the PSC for femtocell 606. The measurement control message indicates an Event 2c trigger type, indicating to report a detected PSC if the quality is above a threshold. The measurement control message includes a 1.28 second time to trigger measurement reporting by the UE 602. The time may allow a stable signal to be detected by the UE 602. The UE 602 moves out of the vicinity of the femtocell 606. During dense transmission gap 714a, transmission between the eNB 604 and UE 602 ceases, and the UE 602 performs measurement reporting. The UE 602 fails to detect the femtocell 606 because the UE 602 has moved outside of the range of femtocell 606. The UE 602 performs 5 more measurements during transmission gaps 714b-f, between transmission periods 704a-e. Because the UE 602 is outside of the range of femtocell 606, the UE 602 fails to detect the femtocell 606 signal above the threshold indicated in the measurement control message. After the 6 repetitions set by the measurement control message, the macro RNC returns the UE 602 to the sparse transmission gap configuration. Thus, during transmission period 702d, the macro RNC configures the UE 602, via the physical channel reconfiguration message and measurement control message to the UE 602, with sparse periodic transmission gaps.

In another example illustrated in FIG. 7B, a UE 602 is configured for sparse transmission gaps and then reconfiguration for dense transmission gaps in a similar fashion as described in FIG. 7A. The UE 602 is in the vicinity of femtocell 606. The UE 602 is initially configured for sparse transmission gaps by the macro RNC, and then reconfigured for dense transmission gaps. At time 710′, the macro RNC configures the UE 602, via a physical channel reconfiguration message to the UE 602, with sparse periodic transmission gaps. The physical channel reconfiguration message indicates a 5 second interval between adjacent gaps, 10 slots per gap, and continuous repetition. The macro RNC also sends a measurement control message to the UE 602 indicating the frequency for femtocell 606 and the PSC for femtocell 606. The measurement control message indicates an Event 2c trigger type, indicating to report a detected PSC if the quality is above a threshold. The measurement control message includes a 0 second time to trigger measurement reporting by the UE 602, to indicate to the UE 602 to report a detected PSC immediately. The UE 602 communicates with the eNB 604 during transmission period 702a′. At transmission gap 712a′, transmission between the eNB 604 and UE 602 ceases, and the UE 602 performs a frequency search, using the frequency of femtocell 606. The UE 602 is outside of the range of femtocell 606 and does not find femtocell 606. During transmission period 702c′, transmission between the eNB 604 and the UE 602 resumes. At transmission gap 712b′, the UE 602 enters the vicinity of femtocell 606 and performs a frequency search, using the frequency of femtocell 606. The UE 602 finds the femtocell and determines the quality of the detected PSC is above the threshold set in the measurement control message. The UE 602 reports the detected PSC of the femtocell 606 to the eNB 604.

During transmission period 702c′, the macro RNC configures UE 602, via a physical channel reconfiguration message to the UE 602, with dense periodic transmission gaps. The physical channel reconfiguration message indicates a 250 millisecond interval between adjacent gaps, 10 slots per gap, and 6 repetitions. The macro RNC also sends a measurement control message to the UE 602 indicating the frequency for femtocell 606 and the PSC for femtocell 606. The measurement control message indicates an Event 2c trigger type, indicating to report a detected PSC if the quality is above a threshold. The measurement control message includes a 1.28 second time to trigger measurement reporting by the UE 602. The time may allow a stable signal to be detected by the UE 602. The UE 602′ remains in the vicinity of the femtocell 606. During dense transmission gap 714a′, transmission between the eNB 604 and UE 602 ceases, and the UE 602 performs measurement reporting. The UE 602 fails to detect the femtocell 606 signal quality above the threshold. The UE 602 performs 3 more measurements during transmission gaps 714b′-d′, between transmission periods 704a′-c′. During transmission gap period 714d′, the UE 602 detects the signal quality of the femtocell 606 above the threshold. The UE 602 waits 1.28 seconds before sending the measurement report including the information for femtocell 606. During transmission period 702d′, the eNB 604 performs handoff of the UE 602 to the femtocell 604.

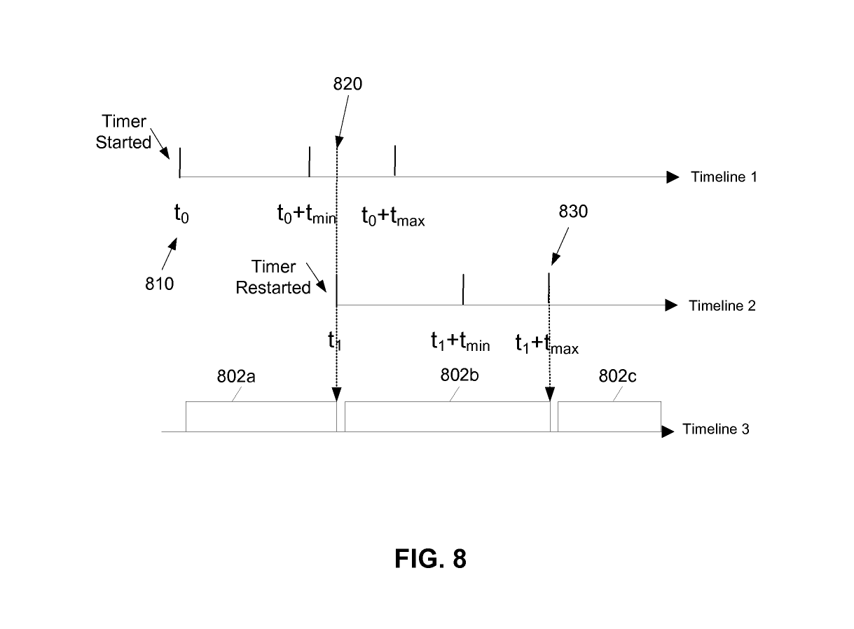

FIG. 8 is an exemplary timeline diagram for traffic demand based configuration for compressed mode. The transmission gaps for the traffic-demand based configuration differ from the blind configuration for compressed mode. In the traffic demand based configuration, those transmissions gaps may be non-periodic and configured at times when the UE has no significant traffic demand, so that the UE may tune to other frequencies for measurement reporting without significantly interrupting data transmission. Significant traffic demand may be indicated by high volume of data to be transmitted (e.g., during transmission periods 802a-c), for example, the MAC layer buffer size or the amount of application layer data exceeds a certain threshold in the UL, DL, or both UL and DL.

In an aspect, the macro RNC serving the UE may start a timer at an initial time (e.g., time t₀), which may be the time when the procedure is initialized or the time when the previous transmission gap is configured. Within a predetermined time period (e.g., between a minimum and maximum time), the macro RNC may configure the next transmission gap whenever the DL and UL MAC layer buffer sizes of the UE are below corresponding thresholds. A minimum time may be used to maintain a minimum time interval between the transmission gaps. The maximum time may enable a deadline for the configuration of the next transmission gap, to ensure that transmission gaps are scheduled during high traffic periods. Thus, the macro RNC may configure the next transmission gap if the timer exceeds the maximum time, even if there is high traffic demand. The macro RNC may obtain the DL and UL buffer size information from the eNB and UE, respectively.

In the example illustrated in FIG. 8, traffic demand based configuration for compressed mode is initialized at 810, time t₀. For example, this may be configured after a connection set up between the UE and eNB. The macro RNC waits at least a minimum time tₘᵢₙ before configuring the next transmission gap. During the predetermined time period (interval t₀+tₘᵢₙ and t₀+tₘₐₓ), the macro RNC determines if traffic demand is below the threshold. The RNC obtains the DL buffer size from the eNB and the UL buffer size from the UE. At time 820, the macro RNC determines that the DL and UL buffer sizes are below the threshold and configures the next transmission gap. The UE performs frequency search during the transmission gap. At time 820, corresponding to t₁, the macro RNC restarts the timer. The macro RNC again waits a minimum time t₁+tₘᵢₙ before configuring the next transmission gap. During the time interval t₁+tₘᵢₙ and tₘₐₓ, the macro RNC determines if traffic demand is below the threshold. The macro RNC obtains the DL buffer size from the eNB and the UL buffer size from the UE. During the time interval t₁+tₘᵢₙ and t₁+tₘₐₓ, the macro RNC determines that the DL and UL buffer sizes are not below the threshold (e.g., there is high traffic demand). The timer expires at time t₁+tₘₐₓ corresponding to time 830. Because the timer expires at time 830, the macro RNC configures a transmission gap even though there is high traffic demand. The UE performs frequency search during the transmission gap. Data transmission resumes after the transmission gap.

In another embodiment, some cells may need to regularly measure out-of-cell signals. For example, some femtocells need to regularly monitor the broadcast information from neighboring cells, and some cells need to periodically measure out-of-cell interference levels. To measure those out-of-cell signals, the cells typically have to shut down their traffic transmissions during a measurement period to prevent jamming the out-of-cell signals. However, this will interrupt the data transmission for the served users.

Most out-of-cell signal measurements are not critical on timing and may be performed within a predetermined time window. Therefore, the cell may schedule the measurement in that predetermined time window when traffic demands of most served users are low to minimize the traffic interruption. The traffic demand may be indicated by the MAC layer buffer size or the amount of application layer data.

In an aspect, the measuring cell may start a timer at an initial time (e.g., time t₀), which may be the time when the procedure is initialized or the time when the previous transmission gap is configured. Within a predetermined time period (e.g., between a minimum and maximum time), the measuring cell may configure the next transmission gap whenever the MAC layer buffer size or application layer data are below corresponding thresholds. A minimum time may be used to maintain a minimum time interval between the transmission gaps. The maximum time may enable a deadline for the configuration of the next transmission gap, to ensure transmission gaps are scheduled during high traffic periods. Thus, the measuring cell may configure the next transmission gap if the timer exceeds the maximum time, even if there is high traffic demand.

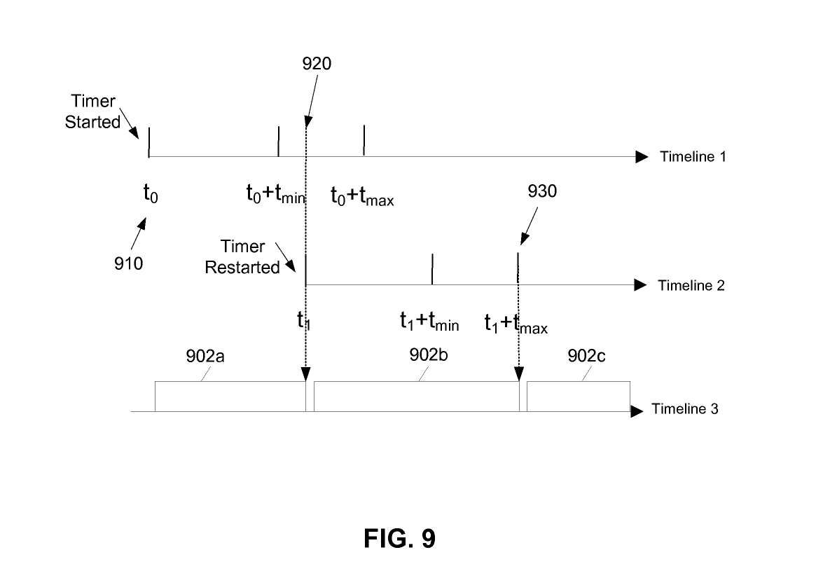

In the example illustrated in FIG. 9, traffic demand based measurement of out-of-cell signals is initialized at 910, time t₀. The measuring cell waits at least a minimum time tₘᵢₙ before configuring the next transmission gap. During the predetermined time period (interval t₀+tₘᵢₙ and t₀+tₘₐₓ), the measuring cell determines if traffic demand is below the threshold. The measuring cell obtains the buffer sizes. At time 920, the measuring cell determines that the buffer sizes are below the threshold and configures the next transmission gap. The measuring cell performs out-of-cell signal measurement during the transmission gap. At time 920, corresponding to t₁, the measuring cell restarts the timer. The measuring cell again waits a minimum time t₁+tₘᵢₙ before configuring the next transmission gap. During the time interval t₁+tₘᵢₙ and t₁+tₘₐₓ, the measuring cell determines if traffic demand is below the threshold. The measuring cell obtains the buffer sizes to determine the demand. During the time interval t₁+tₘᵢₙ and t₁+tₘₐₓ, the measuring cell determines that the buffer sizes are not below the threshold (e.g., there is high traffic demand). The timer expires at time t₁+tₘₐₓ. Because the timer expires, the measuring cell configures a transmission gap even though there is high traffic demand. The measuring cell performs out-of-cell signal measurements during the transmission gap. Data transmission resumes after the transmission gap.

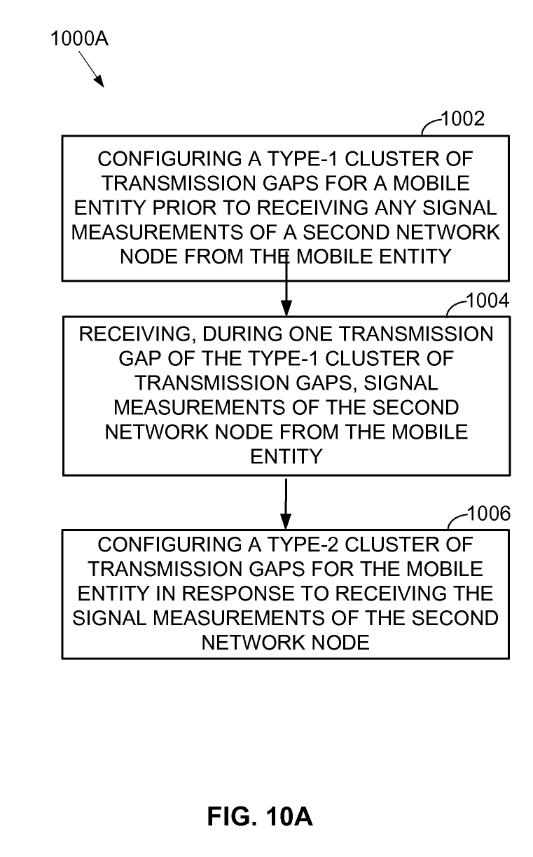

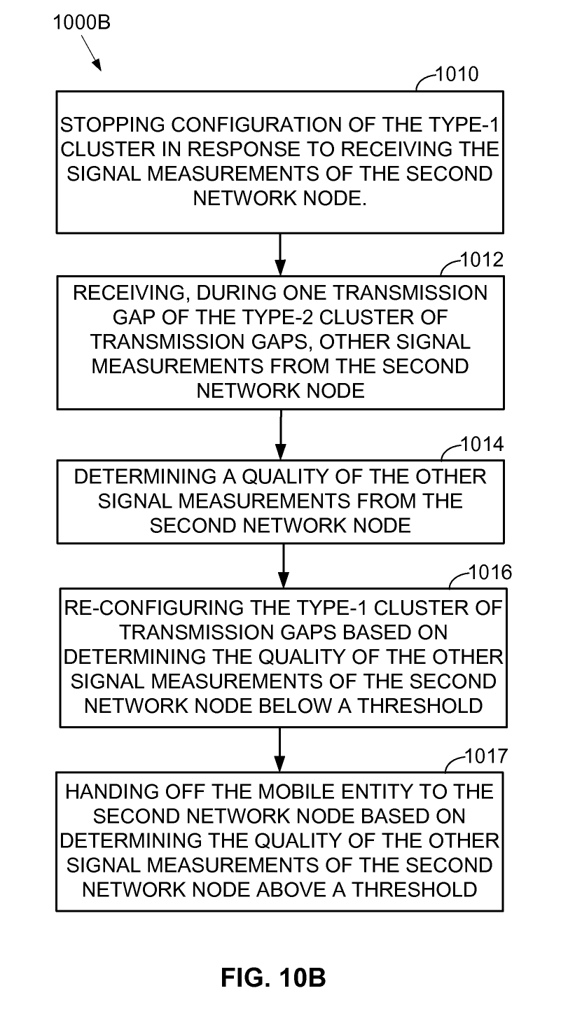

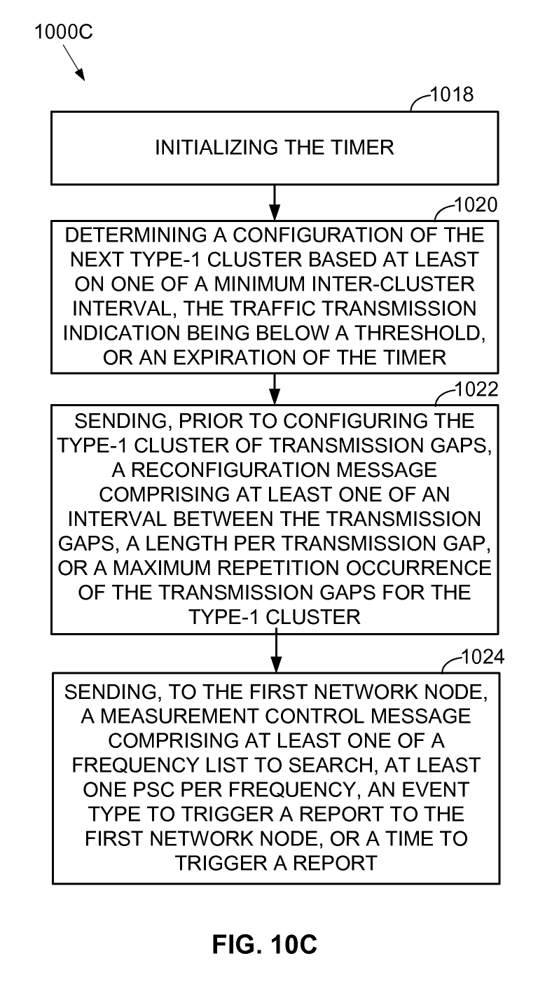

In accordance with one or more aspects of the embodiments described herein, with reference to FIG. 10A, there is shown a methodology 1000A, operable by a network entity, such as, for example, a femtocell, a macrocell, a picocell, or the like. Specifically, method 1000A describes a procedure to configure compressed mode for a UE. The method 1000A may involve, at 1002, configuring a type-1 cluster of transmission gaps for a mobile entity prior to receiving any signal measurements of a second network node from the mobile entity. The method 1000 may involve, at 1004, receiving, during one transmission gap of the type-1 cluster of transmission gaps, signal measurements of the second network node from the mobile entity. The method 1000 may involve, at 1006, configuring a type-2 cluster of transmission gaps for the mobile entity in response to receiving the signal measurements of the second network node.

With reference to FIG. 10B, there are shown further operations 1000B or aspects that are optional and may be performed by a network entity or the like. If the method 1000B includes at least one block, then the method 1000B may terminate after the at least one block of method 1000B, without necessarily having to include any subsequent downstream block(s) that may be illustrated. It is further noted that numbers of the blocks do not imply a particular order in which the blocks may be performed according to the method 1000B. For example, the method 1000B may further include, at 1010, stopping configuration of the type-1 cluster in response to receiving the signal measurements of the second network node. For example, the method 1000B may further include, at 1012, receiving, during one transmission gap of the type-2 cluster of transmission gaps, other signal measurements from the second network node. For example, the method 1000B may further include, at 1014, determining a quality of the other signal measurements from the second network node. For example, the method 1000B may further include, at 1016, re-configuring the type-1 cluster of transmission gaps based on determining the quality of the other signal measurements of the second network node below a threshold. For example, the method 1000B may further include, at 1017, handing off the mobile entity to the second network node based on determining the quality of the other signal measurements of the second network node above a threshold.

With reference to FIG. 10C, there are shown further operations 1000C or aspects that are optional and may be performed by a network entity or the like. If the method 1000C includes at least one block, then the method 1000C may terminate after the at least one block, without necessarily having to include any subsequent downstream block(s) that may be illustrated. It is further noted that numbers of the blocks do not imply a particular order in which the blocks may be performed according to the method 1000C. For example, the method 1000C may, at 1018, initializing the timer. For example, the method 1000C may include, at 1020, determining a configuration of the next type-1 cluster based at least on one of a minimum inter-cluster interval, the traffic transmission indication being below a threshold, or an expiration of the timer. For example, the method 1000C may include, at 1022, sending, prior to configuring the type-1 cluster of transmission gaps, a reconfiguration message comprising at least one of an interval between the transmission gaps, a length per transmission gap, or a maximum repetition occurrence of the transmission gaps for the type-1 cluster. For example, the method 1000C may include, at 1024, sending, to the first network node, a measurement control message comprising at least one of a frequency list to search, at least one PSC per frequency, an event type to trigger a report to the first network node, or a time to trigger a report.

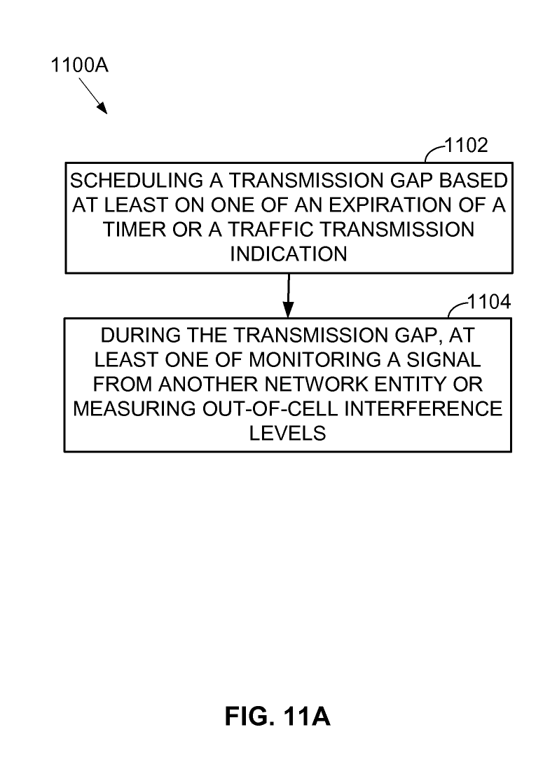

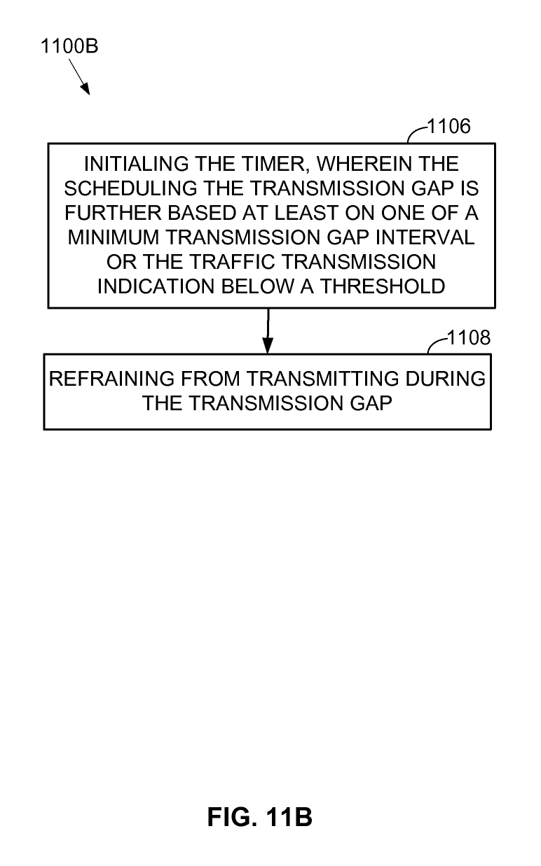

In accordance with one or more aspects another one of the embodiments described herein, with reference to FIG. 11A, there is shown a methodology 1100A, operable by a network entity, such as, for example, a femtocell, a macrocell, a picocell, or the like. Specifically, method 1100 describes a procedure to configure demand-based measurement of out-of-cell signals. Specifically, method 1100A may involve, at 1102, scheduling a transmission gap based at least on one of an expiration of a timer or a traffic transmission indication. The method 1100A may involve, at 1104, during the transmission gap, at least one of monitoring a signal from another network entity or measuring out-of-cell interference levels.

With reference to FIG. 11B, there are shown further operations 1100B or aspects that are optional and may be performed by a network entity or the like. If the method 1100B includes at least one block, then the method 1100B may terminate after the at least one block of method 1100B, without necessarily having to include any subsequent downstream block(s) that may be illustrated. It is further noted that numbers of the blocks do not imply a particular order in which the blocks may be performed according to the method 1100B. For example, the method 1100B may further include, at 1106, initialing the timer, wherein the scheduling the transmission gap is further based at least on one of a minimum transmission gap interval or the traffic transmission indication below a threshold. For example, the method 1100B may further include, at 1108, refraining from transmitting during the transmission gap.

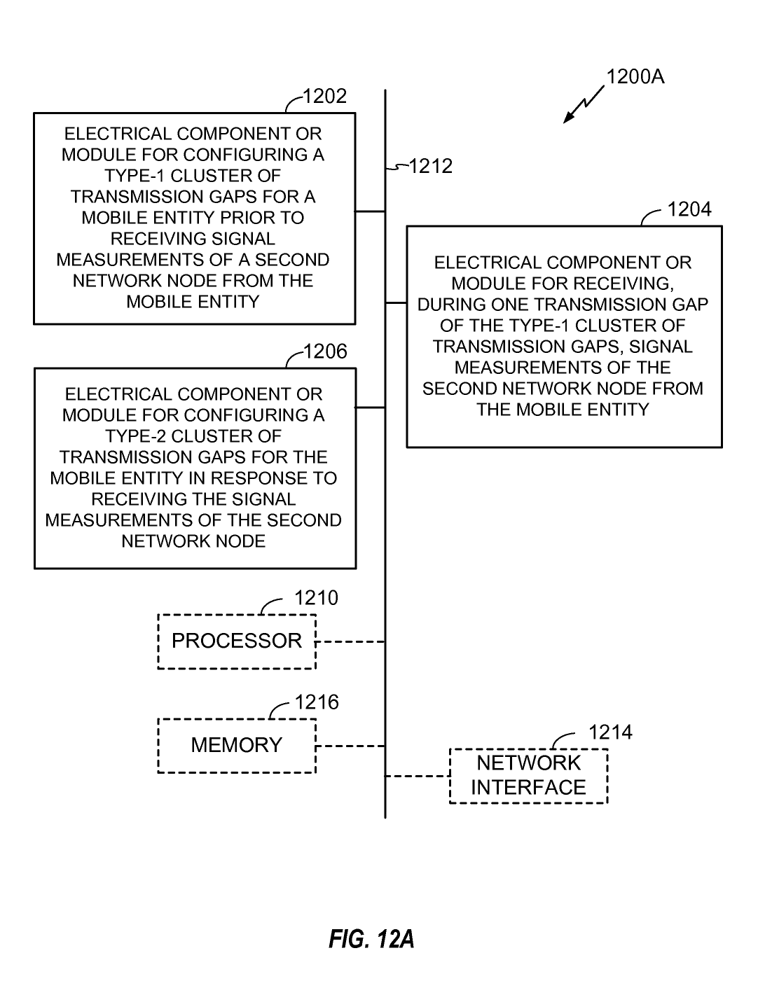

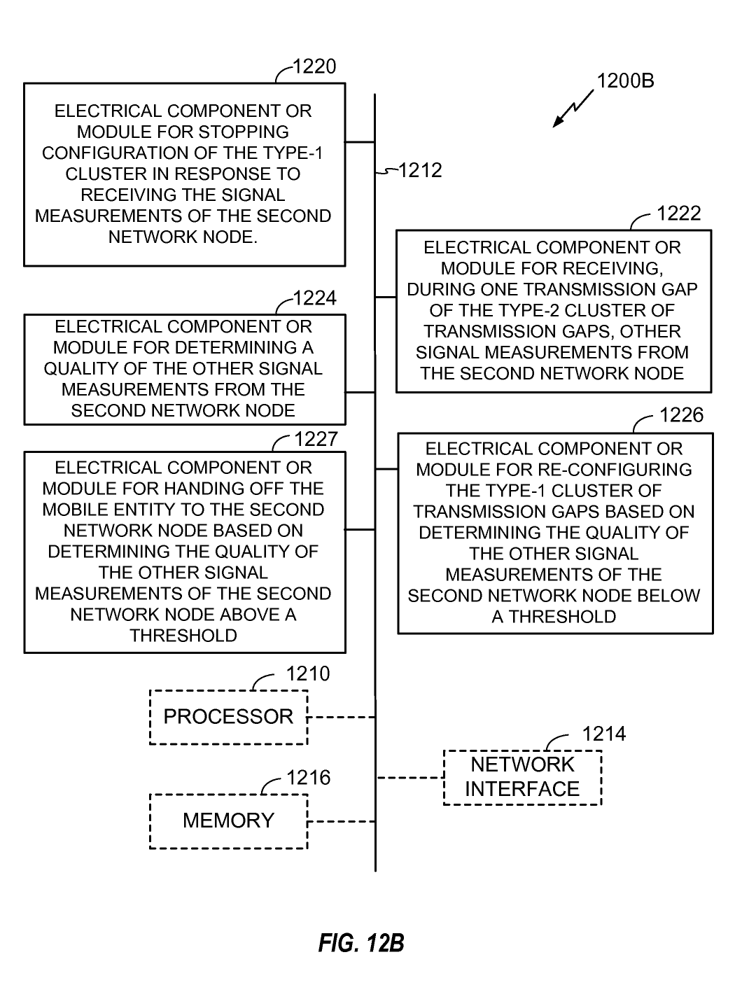

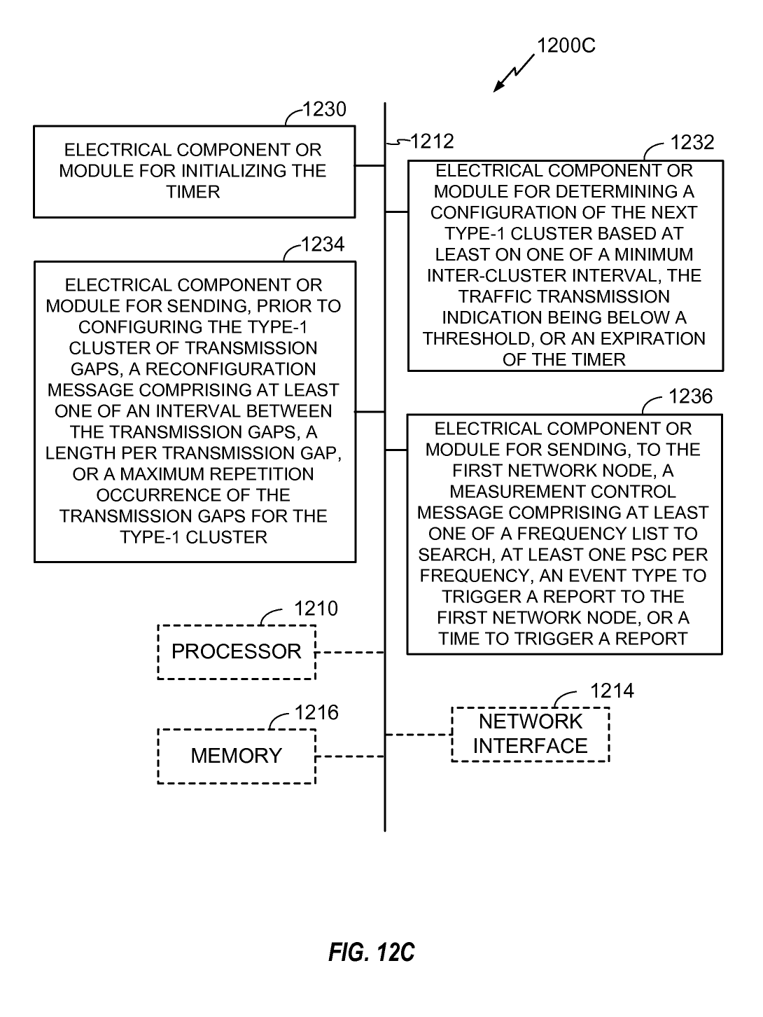

FIG. 12A shows an embodiment of an apparatus for configuring compressed mode for a UE, in accordance with the methodology of FIG. 10A. With reference to FIG. 12, there is provided an exemplary apparatus 1200A that may be configured as a network entity (e.g., a femtocell, a macrocell, a picocell, or the like) in a wireless network, or as a processor or similar device/component for use within the network entity. The apparatus 1200A may include functional blocks that can represent functions implemented by a processor, software, or combination thereof (e.g., firmware). For example, apparatus 1200A may include an electrical component or module 1202 for configuring a type-1 cluster of transmission gaps for a mobile entity prior to receiving signal measurements of a second network node from the mobile entity. The apparatus 1200A may include an electrical component or module 1204 for receiving, during one transmission gap of the type-1 cluster of transmission gaps, signal measurements of the second network node from the mobile entity. The apparatus 1200A may include an electrical component or module 1206 for configuring a type-2 cluster of transmission gaps for the mobile entity in response to receiving the signal measurements of the second network node.

In related aspects, the apparatus 1200A may optionally include a processor component 1250 having at least one processor, in the case of the apparatus 1200 configured as a network entity (e.g., a femtocell, a macrocell, a picocell, or the like), rather than as a processor. The processor 1250, in such case, may be in operative communication with the components 1202-1206 via a bus 1252 or similar communication coupling. The processor 1250 may effect initiation and scheduling of the processes or functions performed by electrical components 1202-1206.

In further related aspects, the apparatus 1200 may include a radio transceiver component 1254. A stand-alone receiver and/or stand-alone transmitter may be used in lieu of or in conjunction with the transceiver 1254. When the apparatus 1200 is a network entity, the apparatus 1200 may also include a network interface (not shown) for connecting to one or more core network entities. The apparatus 1200 may optionally include a component for storing information, such as, for example, a memory device/component 1256. The computer readable medium or the memory component 1256 may be operatively coupled to the other components of the apparatus 1200 via the bus 1252 or the like. The memory component 1256 may be adapted to store computer readable instructions and data for effecting the processes and behavior of the components 1202-1206, and subcomponents thereof, or the processor 1250, or the methods disclosed herein. The memory component 1256 may retain instructions for executing functions associated with the components 1202-1206. While shown as being external to the memory 1256, it is to be understood that the components 1202-1206 can exist within the memory 1256. It is further noted that the components in FIG. 12 may comprise processors, electronic devices, hardware devices, electronic sub-components, logical circuits, memories, software codes, firmware codes, etc., or any combination thereof.

With reference to FIG. 12B, there are shown further optional components or modules of apparatus 1200A. For example, the apparatus 1200B may further include a component or module 1220 for stopping configuration of the type-1 cluster in response to receiving the signal measurements of the second network node. For example, the apparatus 1200B may further include a component or module 1222 for receiving, during one transmission gap of the type-2 cluster of transmission gaps, other signal measurements from the second network node. The apparatus 1200B may further include a component or module 1224 for determining a quality of the other signal measurements from the second network node. The apparatus 1200B may further include a component or module 1226 for re-configuring the type-1 cluster of transmission gaps based on determining the quality of the other signal measurements of the second network node below a threshold. The apparatus 1200B may further include a component or module 1227 for handing off the mobile entity to the second network node based on determining the quality of the other signal measurements of the second network node above a threshold.

With reference to FIG. 12C, there are shown further optional components or modules of apparatus 1200A. For example, the apparatus 1200C may further include a component or module 1230 for initializing the timer. For example, the apparatus 1200C may further include a component or module 1232 for determining a configuration of the next type-1 cluster based at least on one of a minimum inter-cluster interval, the traffic transmission indication being below a threshold, or an expiration of the timer. The apparatus 1200C may further include a component or module 1234 for sending, prior to configuring the type-1 cluster of transmission gaps, a reconfiguration message comprising at least one of an interval between the transmission gaps, a length per transmission gap, or a maximum repetition occurrence of the transmission gaps for the type-1 cluster. The apparatus 1200C may further include a component or module 1236 for sending, to the first network node, a measurement control message comprising at least one of a frequency list to search, at least one PSC per frequency, an event type to trigger a report to the first network node, or a time to trigger a report.

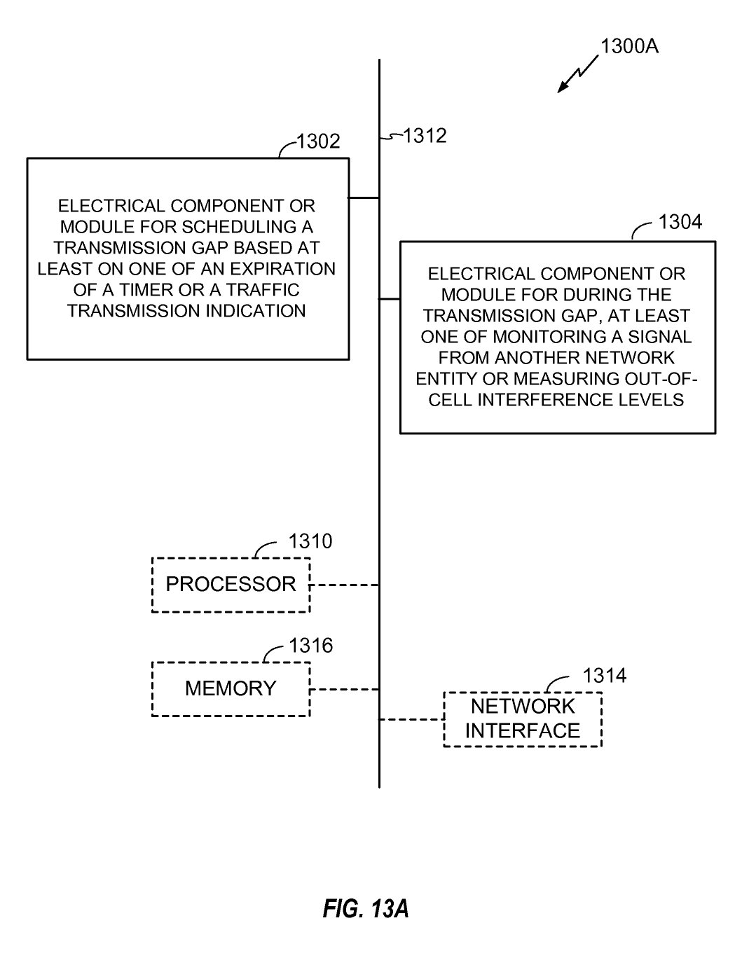

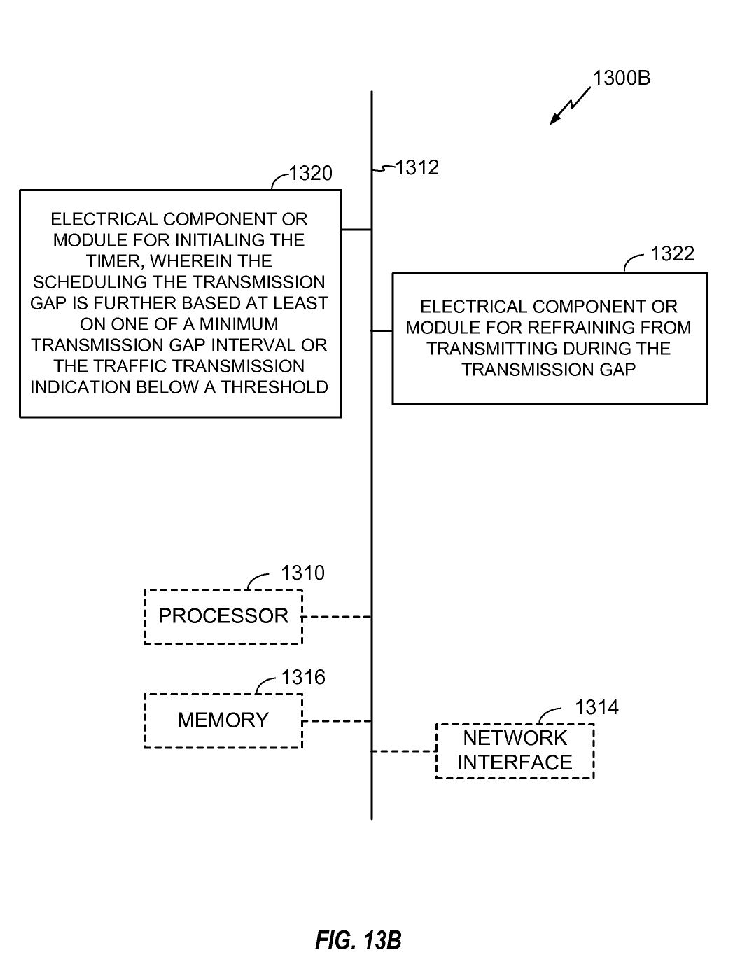

FIG. 13A shows an embodiment of an apparatus for configuring demand-based measurement of out-of-cell signals, in accordance with the methodology of FIG. 11A. With reference to FIG. 13A, there is provided an exemplary apparatus 1300A that may be configured as a network entity (e.g., a femtocell, a macrocell, a picocell, or the like) in a wireless network, or as a processor or similar device/component for use within the network entity. The apparatus 1300A may include functional blocks that can represent functions implemented by a processor, software, or combination thereof (e.g., firmware). For example, apparatus 1300A may include an electrical component or module 1302 for scheduling a transmission gap based at least on one of an expiration of a timer or a traffic transmission indication. The apparatus 1300A may include an electrical component or module 1304 for during the transmission gap, at least one of monitoring a signal from another network entity or measuring out-of-cell interference levels.

In related aspects, the apparatus 1300A may optionally include a processor component 1350 having at least one processor, in the case of the apparatus 1300A configured as a network entity (e.g., a femtocell, a macrocell, a picocell, or the like), rather than as a processor. The processor 1350, in such case, may be in operative communication with the components 1302-1304 via a bus 1352 or similar communication coupling. The processor 1350 may effect initiation and scheduling of the processes or functions performed by electrical components 1302-1304.

In further related aspects, the apparatus 1300A may include a radio transceiver component 1354. A stand-alone receiver and/or stand-alone transmitter may be used in lieu of or in conjunction with the transceiver 1354. When the apparatus 1300A is a network entity, the apparatus 1300A may also include a network interface (not shown) for connecting to one or more core network entities. The apparatus 1300A may optionally include a component for storing information, such as, for example, a memory device/component 1356. The computer readable medium or the memory component 1356 may be operatively coupled to the other components of the apparatus 1300A via the bus 1352 or the like. The memory component 1356 may be adapted to store computer readable instructions and data for effecting the processes and behavior of the components 1302-1304, and subcomponents thereof, or the processor 1350, or the methods disclosed herein. The memory component 1356 may retain instructions for executing functions associated with the components 1302-1304. While shown as being external to the memory 1356, it is to be understood that the components 1302-1304 can exist within the memory 1356. It is further noted that the components in FIG. 13 may comprise processors, electronic devices, hardware devices, electronic sub-components, logical circuits, memories, software codes, firmware codes, etc., or any combination thereof.

With reference to FIG. 13B, there are shown further optional components or modules of apparatus 1300A. For example, the apparatus 1300B may further include a component or module 1320 for initialing the timer, wherein the scheduling the transmission gap is further based at least on one of a minimum transmission gap interval or the traffic transmission indication below a threshold. For example, the apparatus 1300B may further include a component or module 1322 for refraining from transmitting during the transmission gap.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A wireless communication method operable by a first network node, the method comprising:
configuring a type-1 cluster of transmission gaps for a mobile entity prior to receiving signal measurements of a second network node from the mobile entity;
receiving, during one transmission gap of the type-1 cluster of transmission gaps, signal measurements of the second network node from the mobile entity; and
configuring a type-2 cluster of transmission gaps for the mobile entity in response to receiving the signal measurements of the second network node.

2. The method of claim 1, further comprising stopping configuration of the type-1 cluster in response to receiving the signal measurements of the second network node.

3. The method of claim 1, wherein the type-1 cluster comprises transmission gaps having a predetermined density, while the type-2 cluster comprises transmission gaps having a higher density than the transmission gaps of the type-1 cluster.

4. The method of claim 1, further comprising:
receiving, during one transmission gap of the type-2 cluster of transmission gaps, other signal measurements from the second network node; and
determining a quality of the other signal measurements from the second network node.

5. The method of claim 4, further comprising re-configuring the type-1 cluster of transmission gaps based on determining the quality of the other signal measurements of the second network node below a threshold.

6. The method of claim 4, further comprising handing off the mobile entity to the second network node based on determining the quality of the other signal measurements of the second network node above a threshold.

7. The method of claim 1, wherein the type-1 cluster is defined by at least one of a periodic cluster pattern or a non-periodic cluster pattern.

8. The method of claim 7, wherein the type-1 cluster is defined by the non-periodic cluster pattern, and a next type-1 cluster is configured based on at least one of a timer at the first network node or a traffic transmission indication, wherein the method further comprises:
initializing the timer; and
determining a configuration of the next type-1 cluster based at least on one of a minimum inter-cluster interval, the traffic transmission indication being below a threshold, or an expiration of the timer.

9. The method of claim 8, wherein the traffic transmission indication is associated with at least one of (i) a media access control (MAC) layer buffer size or (ii) application layer data in an uplink, downlink, or both the uplink and the downlink.

10. The method of claim 1, wherein the first network node is configured for a first frequency and the second network node is configured for a second frequency different from the first frequency.

11. The method of claim 1, wherein the signal measurements of the second network node comprise a primary synchronization code (PSC).

12. The method of claim 1, further comprising sending, prior to configuring the type-1 cluster of transmission gaps, a reconfiguration message comprising at least one of an interval between the transmission gaps, a length per transmission gap, or a maximum repetition occurrence of the transmission gaps for the type-1 cluster.

13. The method of claim 1, further comprising sending, to the first network node, a measurement control message comprising at least one of a frequency list to search, at least one PSC per frequency, an event type to trigger a report to the first network node, or a time to trigger a report.

14. A wireless communication apparatus comprising:
at least one processor configured to:
configure a type-1 cluster of transmission gaps for a mobile entity prior to receiving signal measurements of a second network node from the mobile entity,
receive, during one transmission gap of the type-1 cluster of transmission gaps, signal measurements of the second network node from the mobile entity, and
configure a type-2 cluster of transmission gaps for the mobile entity in response to receiving the signal measurements of the second network node; and
a memory coupled to the at least one processor for storing data.

15. The wireless communication apparatus of claim 14, wherein the at least one processor is further configured to stop configuration of the type-1 cluster in response to receiving the signal measurements of the second network node.

16. The wireless communication apparatus of claim 14, wherein the type-1 cluster comprises transmission gaps having a predetermined density, while the type-2 cluster comprises transmission gaps having a higher density than the transmission gaps of the type-1 cluster.

17. The wireless communication apparatus of claim 14, wherein the at least one processor is further configured to:
receive, during one transmission gap of the type-2 cluster of transmission gaps, other signal measurements from the second network node, and
determine a quality of the other signal measurements from the second network node.

18. The wireless communication apparatus of claim 17, wherein the at least one processor is further configured to re-configure the type-1 cluster of transmission gaps based on determining the quality of the other signal measurements of the second network node below a threshold.

19. The wireless communication apparatus of claim 17, wherein the at least one processor is further configured to hand off the mobile entity to the second network node based on determining the quality of the other signal measurements of the second network node above a threshold.

20. The wireless communication apparatus of claim 14, wherein the type-1 cluster is defined by at least one of a periodic cluster pattern or a non-periodic cluster pattern.

21. The wireless communication apparatus of claim 20, wherein the type-1 cluster is defined by the non-periodic cluster pattern, and a next type-1 cluster is configured based on at least one of a timer at the first network node or a traffic transmission indication, wherein the at least one processor is further configured to:
initialize the timer; and
determine a configuration of the next type-1 cluster based at least on one of a minimum inter-cluster interval, the traffic transmission indication being below a threshold, or an expiration of the timer.

22. A wireless communication apparatus comprising:
means for configuring a type-1 cluster of transmission gaps for a mobile entity prior to receiving signal measurements of a second network node from the mobile entity;
means for receiving, during one transmission gap of the type-1 cluster of transmission gaps, signal measurements of the second network node from the mobile entity; and
means for configuring a type-2 cluster of transmission gaps for the mobile entity in response to receiving the signal measurements of the second network node.

23. The wireless communication apparatus of claim 22, further comprising means for stopping configuration of the type-1 cluster in response to receiving the signal measurements of the second network node.

24. The wireless communication apparatus of claim 22, wherein the type-1 cluster comprises transmission gaps having a predetermined density, while the type-2 cluster comprises transmission gaps having a higher density than the transmission gaps of the type-1 cluster.

25. The wireless communication apparatus of claim 22, further comprising:
receiver means for receiving, during one transmission gap of the type-2 cluster of transmission gaps, other signal measurements from the second network node; and
means for determining a quality of the other signal measurements from the second network node.

26. The wireless communication apparatus of claim 25, further comprising means for re-configuring the type-1 cluster of transmission gaps based on determining the quality of the other signal measurements of the second network node below a threshold.

27. The wireless communication apparatus of claim 25, further comprising means for handing off the mobile entity to the second network node based on determining the quality of the other signal measurements of the second network node above a threshold.

28. The wireless communication apparatus of claim 22, wherein the type-1 cluster is defined by at least one of a periodic cluster pattern or a non-periodic cluster pattern.

29. The wireless communication apparatus of claim 28, wherein the type-1 cluster is defined by the non-periodic cluster pattern, and a next type-1 cluster is configured based on at least one of a timer means at the first network node or a traffic transmission indication, wherein the wireless communication apparatus further comprises:
means for initializing the timer means; and
means for determining a configuration of the next type-1 cluster based at least on one of a minimum inter-cluster interval, the traffic transmission indication being below a threshold, or an expiration of the timer.

30. A computer program product, comprising:
a computer-readable medium comprising code for causing at least one computer to:
configure a type-1 cluster of transmission gaps for a mobile entity prior to receiving signal measurements of a second network node from the mobile entity;
receive, during one transmission gap of the type-1 cluster of transmission gaps, signal measurements of the second network node from the mobile entity; and
configure a type-2 cluster of transmission gaps for the mobile entity in response to receiving the signal measurements of the second network node.

31. The computer program product of claim 30, wherein the computer-readable medium further comprises code for causing the at least one computer to stop configuration of the type-1 cluster in response to receiving the signal measurements of the second network node.

32. The computer program product of claim 30, wherein the type-1 cluster comprises transmission gaps having a predetermined density, while the type-2 cluster comprises transmission gaps having a higher density than the transmission gaps of the type-1 cluster.

33. The computer program product of claim 30, wherein the computer-readable medium further comprises code for causing the at least one computer to:
receive, during one transmission gap of the type-2 cluster of transmission gaps, other signal measurements from the second network node; and
determine a quality of the other signal measurements from the second network node.

34. The computer program product of claim 33, wherein the computer-readable medium further comprises code for causing the at least one computer to re-configure the type-1 cluster of transmission gaps based on determining the quality of the other signal measurements of the second network node below a threshold.

35. The computer program product of claim 33, wherein the computer-readable medium further comprises code for causing the at least one computer to hand off the mobile entity to the second network node based on determining the quality of the other signal measurements of the second network node above a threshold.

36. The computer program product of claim 30, wherein the type-1 cluster is defined by at least one of a periodic cluster pattern or a non-periodic cluster pattern.

37. The computer program product of claim 36, wherein type-1 cluster is defined by the non-periodic cluster pattern, and a next type-1 cluster is configured based at least one of a timer at the first network node or a traffic transmission indication, wherein the computer-readable medium further comprises code for causing the at least one computer to:
initialize the timer; and
determine a configuration of the next type-1 cluster based at least on one of a minimum inter-cluster interval, the traffic transmission indication being below a threshold, or an expiration of the timer.

38. A wireless communication method operable by a network entity, the method comprising:
scheduling a transmission gap based at least on one of an expiration of a timer or a traffic transmission indication; and
during the transmission gap, at least one of monitoring a signal from another network entity or measuring out-of-cell interference levels.

39. The method of claim 38, further comprising:
initialing the timer, wherein the scheduling the transmission gap is further based at least on one of a minimum transmission gap interval or the traffic transmission indication below a threshold.

40. The method of claim 38, wherein the traffic transmission indication is based at least on one of a MAC layer buffer size or application layer data in an uplink, downlink, or both the uplink and the downlink.

41. The method of claim 38, further comprising refraining from transmitting during the transmission gap.

42. A wireless communication apparatus comprising:
at least one processor configured to:
schedule a transmission gap based at least on one of an expiration of a timer or a traffic transmission indication, and
during the transmission gap, at least one of monitor a signal from another network entity or measure out-of-cell interference levels; and
a memory coupled to the at least one processor for storing data.

43. The wireless communication apparatus of claim 42, wherein the at least one processor is further configured to initial the timer, wherein the scheduling the transmission gap is further based at least on one of a minimum transmission gap interval or the traffic transmission indication below a threshold.

44. A wireless communication apparatus comprising:
means for scheduling a transmission gap based at least on one of an expiration of a timer or a traffic transmission indication; and
means for, during the transmission gap, at least one of monitoring a signal from another network entity or measuring out-of-cell interference levels.

45. The wireless communication apparatus of claim 44, further comprising means for initializing the timer, wherein the scheduling the transmission gap is further based at least on one of a minimum transmission gap interval or the traffic transmission indication below a threshold.

46. A computer program product, comprising:
a computer-readable medium comprising code for causing at least one computer to:
schedule a transmission gap based at least on one of an expiration of a timer or a traffic transmission indication; and
during the transmission gap, at least one of monitor a signal from another network entity or measure out-of-cell interference levels.

47. The computer program product of claim 46, wherein the computer-readable medium further comprises code for causing the at least one computer to initialize the timer, wherein the scheduling the transmission gap is further based at least on one of a minimum transmission gap interval or the traffic transmission indication below a threshold.
